(19) United States
(12) Patent Application Publication
(10) Pub. No.: US 2017/0131833 A1
(43) Pub. Date: May 11, 2017

(54) DISPLAY INPUT DEVICE, IMAGE FORMING APPARATUS PROVIDED WITH THE SAME, AND METHOD FOR CONTROLLING DISPLAY INPUT DEVICE

(71) Applicant: KYOCERA Document Solutions Inc., Osaka (JP)

(72) Inventor: Kazuhiko MIYAMOTO, Osaka (JP)

(73) Assignee: KYOCERA Document Solutions Inc., Osaka (JP)

(21) Appl. No.: 15/344,111

(22) Filed: Nov. 4, 2016

(30) Foreign Application Priority Data
Nov. 10, 2015 (JP) 2015-220212

(51) Int. Cl. G06F 3/041; G06F 3/0483; H04N 1/00

(52) U.S. Cl. CPC G06F 3/0416; H04N 1/00411; H04N 1/00458; G06F 3/0483; H04N 2201/0094; G06F 2203/04104

(57) ABSTRACT

Upon detecting an operation of touching two points on a preview screen, a display input device displays a page search image including a circular arc about either of touched positions of the two points. Upon detecting an operation in which, while a touch on a center position is continued, the page search image is touched, the display input device sets, as a first position, a position on the circular arc corresponding to a thus touched position on the page search image, sets, as a starting point position, either of positions of a pair of end portions of the circular arc, and performs control so that a value of a page number of a page to be displayed increases with increasing value of a ratio of a length of the circular arc between the starting point position and the first position to a total length of the circular arc.

### INCORPORATION BY REFERENCE

This application is based upon and claims the benefit of priority from the corresponding Japanese Patent Application No. 2015-220212 filed on Nov. 10, 2015, the entire contents of which are incorporated herein by reference.

### BACKGROUND

The present disclosure relates to a display input device, an image forming apparatus provided with the same, and a method for controlling a display input device.

Conventionally, there is known a display input device that stores a page (a page image of each page) contained in an electronic file such as a document file or an image file and displays the page. For example, a conventional display input device (image display device) is provided with a touch panel display. Further, such a display input device displays, on the touch panel display, a thumbnail of a page contained in an electronic file.

Upon detecting, during the time of displaying the page contained in the electronic file, that a page feed operation that is a preset touch operation has been performed with respect to a display screen of the touch panel display, the above-described conventional display input device performs switching of a display page from the currently displayed page to a next page (or a previous page). An operation detected as the page feed operation is such that, while the display screen is being touched, a touched position thereon is moved in a circle. Further, by performing the page feed operation once, page feed of one page is performed.

### SUMMARY

A display input device according to a first aspect of the present disclosure is provided with a control portion, a display portion, and a touch panel portion. The control portion is provided with a CPU. Under control by the control portion, the display portion displays a preview screen for previewing a plurality of pages page by page. The touch panel portion is provided on the display portion and detects a touch operation with respect to the preview screen. Based on an output of the touch panel portion, the control portion performs detection of a touch operation. Upon detecting a touch operation of touching two points on the preview screen, the control portion judges that a search start operation that is performed to search for a page desired by a user to be displayed has been detected. In this case, the control portion sets, as a center position, either of touched positions of two-point touches detected as the search start operation, and controls the display portion to display a page search image that is an image having a circular arc shape including a circular arc about the center position. After the page search image has been displayed, upon detecting a page search operation that is a touch operation in which, while the touch on the center position is continued, the page search image is touched, the control portion sets, as a first position, a position on the circular arc corresponding to a touched position of a touch on the page search image, and sets, as a starting point position, a position of either of a pair of end portions of the circular arc. The control portion further determines a first ratio that is a ratio of a length of the circular arc between the starting point position and the first position to a total length of the circular arc, and controls the display portion to perform switching of a page to be displayed on the preview screen in such a manner that a value of a page number of the page to be displayed on the preview screen by the display portion increases with increasing value of the first ratio.

An image forming apparatus according to a second aspect of the present disclosure is provided with the above-described display input device.

A method for controlling a display input device according to a third aspect of the present disclosure is a method for controlling a display input device provided with a display portion that displays a preview screen for previewing a plurality of pages page by page and a touch panel portion that is provided on the display portion and is used to detect a touch operation with respect to the preview screen. The method includes a step in which, based on an output of the touch panel portion, a touch operation is detected, and upon detecting a touch operation of touching two points on the preview screen, it is judged that a search start operation that is performed to search for a page desired by a user to be displayed has been detected, in which case, either of touched positions of two-point touches detected as the search start operation is set as a center position, and the display portion is controlled to display a page search image that is an image having a circular arc shape including a circular arc about the center position, and a step in which, after the page search image has been displayed, upon detecting a page search operation that is a touch operation in which, while the touch on the center position is continued, the page search image is touched, a position on the circular arc corresponding to the touched position of the touch on the page search image is set as a first position, a position of either of a pair of end portions of the circular arc is set as a starting point position, a first ratio that is a ratio of a length of the circular arc between the starting point position and the first position to a total length of the circular arc is determined, and the display portion is controlled to perform switching of a page to be displayed on the preview screen in such a manner that a value of a page number of the page to be displayed on the preview screen by the display portion increases with increasing value of the first ratio.

### BRIEF DESCRIPTION OF THE DRAWINGS

FIG. 1 is a diagram showing an image forming apparatus according to one embodiment of the present disclosure.

FIG. 2 is a diagram showing an operation panel (display input device) according to the one embodiment of the present disclosure.

FIG. 3 is a diagram showing a hardware configuration of the image forming apparatus and the operation panel according to the one embodiment of the present disclosure.

FIG. 4 is a diagram showing a preview screen displayed by the operation panel according to the one embodiment of the present disclosure.

FIG. 5 is a diagram showing a display action at the time when the operation panel according to the one embodiment of the present disclosure has detected a search start operation (a diagram in a case of a search start operation performed with a right hand).

FIG. 6 is a diagram for explaining a process (setting of a center position) performed when the operation panel according to the one embodiment of the present disclosure has detected a search start operation.

FIG. 7 is a diagram for explaining a process (setting of a first position and a starting point position) performed when the operation panel according to the one embodiment of the present disclosure has detected a page search operation.

FIG. 8 is a diagram showing a display action at the time when the operation panel according to the one embodiment of the present disclosure has detected a search start operation (a diagram in a case of a search start operation performed with a left hand).

FIG. 9 is a diagram showing a display action at the time when the operation panel according to the one embodiment of the present disclosure has detected a page search operation.

FIG. 10 is a diagram showing a display action at the time when the operation panel according to the one embodiment of the present disclosure has sequentially detected a page search operation (when a subject touched position has been moved).

FIG. 11 is a diagram showing a display action at the time when the operation panel according to the one embodiment of the present disclosure has detected a release of all touches.

FIG. 12 is a diagram showing a table of contents page included in a plurality of pages preview-displayed by the operation panel according to the one embodiment of the present disclosure.

FIG. 13 is a diagram for explaining a process (setting of a second position) performed when the operation panel according to the one embodiment of the present disclosure displays item information.

FIG. 14 is a diagram for explaining a process (setting of a third position) performed when the operation panel according to the one embodiment of the present disclosure displays keyword information.

FIG. 15 is a flow chart for explaining a flow of a process at the time when the operation panel according to the one embodiment of the present disclosure performs switching of a display page.

### DETAILED DESCRIPTION

The following describes an image forming apparatus provided with a display input device according to one embodiment of the present disclosure by using, as an example, an image forming apparatus (multi-functional peripheral) equipped with a plurality of types of functions such as a copy function and a printer function.

### <<Overall Configuration of Image Forming Apparatus>>

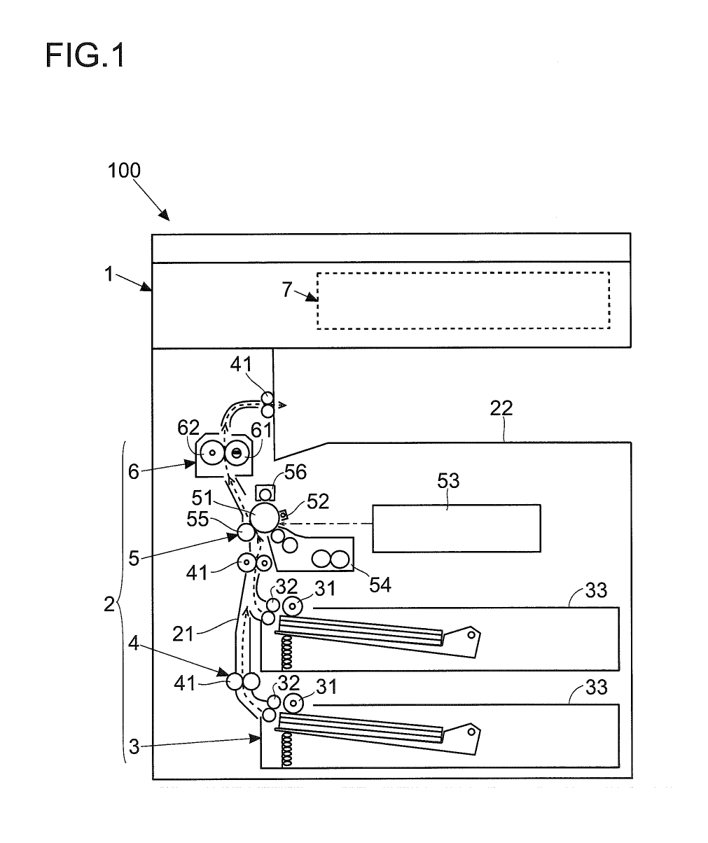

As shown in FIG. 1, an image forming apparatus 100 is provided with an image reading portion 1 and a printing portion 2. The image reading portion 1 reads an original document and based thereon, generates image data of the original document. The printing portion 2 conveys a paper sheet along a paper sheet conveyance path 21 and based on the image data, forms a toner image. Further, the printing portion 2 transfers (prints) the toner image on the paper sheet being conveyed. Furthermore, the printing portion 2 ejects the printed paper sheet on an ejection tray 22.

The printing portion 2 is composed of a paper feed portion 3, a paper sheet conveyance portion 4, an image forming portion 5, and a fixing portion 6. The paper feed portion 3 includes a pick-up roller 31 and a paper feed roller pair 32 and supplies a paper sheet housed in a paper sheet cassette 33 to the paper sheet conveyance path 21. The paper sheet conveyance portion 4 includes a plurality of conveyance roller pairs 41 and conveys the paper sheet along the paper sheet conveyance path 21.

The image forming portion 5 includes a photosensitive drum 51, a charging device 52, an exposure device 53, a developing device 54, a transfer roller 55, and a cleaning device 56. Further, based on image data, the image forming portion 5 forms a toner image, and transfers the toner image on a paper sheet. The fixing portion 6 includes a heating roller 61 and a pressing roller 62 to heat and press the toner image transferred on the paper sheet so that the toner image is fixed thereon.

Here, an operation panel 7 is installed on the image forming apparatus 100. The operation panel 7 corresponds to a “display input device”. The operation panel 7 is disposed on, for example, a front surface side of the image forming apparatus 100 (at an area indicated by a broken line in FIG. 1).

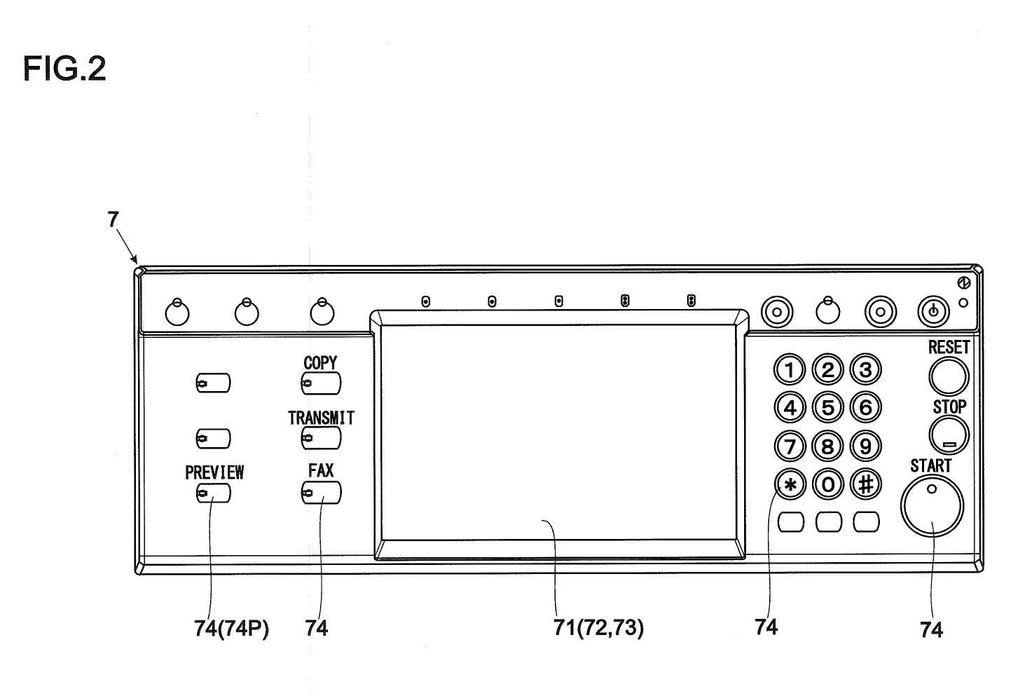

As shown in FIG. 2, a touch panel display 71 is provided on the operation panel 7. The touch panel display 71 includes a display portion 72 and a touch panel portion 73. The display portion 72 is a display panel such as a liquid crystal display panel or an organic EL display panel. The touch panel portion 73 is a touch panel of a resistance film type or a capacitance type and is disposed so as to cover a display screen of the display portion 72. For example, the touch panel display 71 displays, on the display portion 72, software keys for accepting various types of settings such as a setting of a job execution condition and accepts the various types of settings from a user via the touch panel portion 73 (accepts a touch operation with respect to the software keys). On the operation panel 7, various hardware keys 74 such as a start key, a stop key, a reset key, and a numeric keypad also are provided.

### <<Hardware Configuration of Image Forming Apparatus (Operation Panel)>>

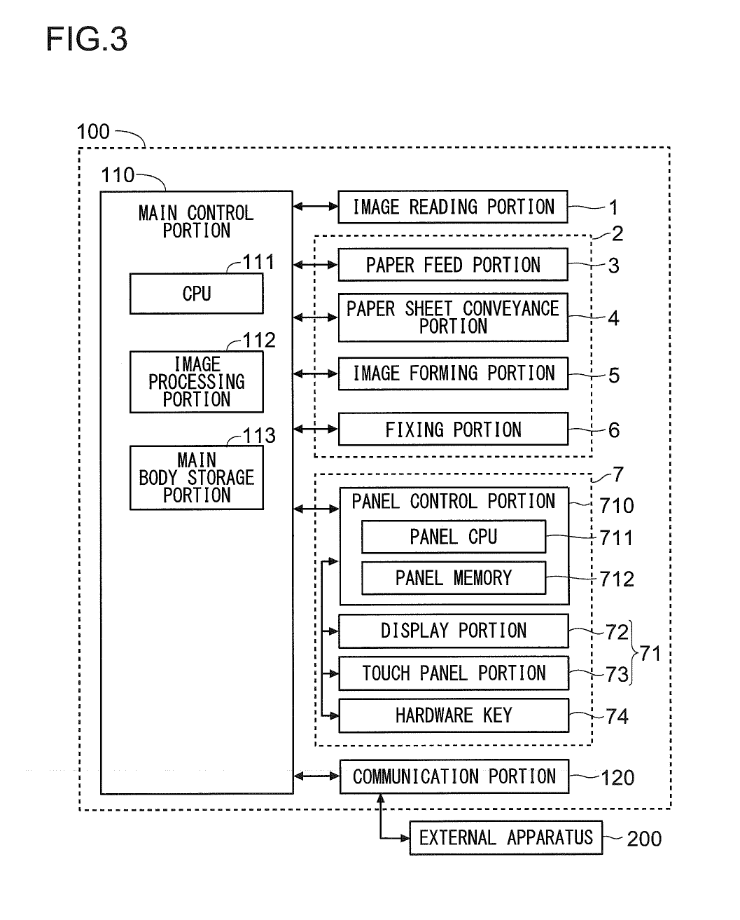

As shown in FIG. 3, the image forming apparatus 100 is provided with a main control portion 110. The main control portion 110 includes a CPU 111, an image processing portion 112, and a main body storage portion 113. The image processing portion 112 performs image processing (enlargement/reduction, concentration conversion, data format conversion, and so on) with respect to image data. The main body storage portion 113 stores control programs and data. Further, based on the control programs and data, the main control portion 110 controls a reading action of the image reading portion 1 and a printing action of the printing portion 2 (the paper feed portion 3, the paper sheet conveyance portion 4, the image forming portion 5, and the fixing portion 6).

Furthermore, the main control portion 110 is connected to a communication portion 120 that has a fax modem and so on incorporated therein. The communication portion 120 is communicably connected to an external apparatus 200. For example, a personal computer (PC) used by a user is connected to the communication portion 120 via a LAN. Alternatively, a facsimile is connected to the communication portion 120 via a telephone line. This enables transmission of image data generated at the image forming apparatus 100 (for example, image data of an original document obtained by reading the original document by the image reading portion 1) to the external apparatus 200. This also enables transmission of various types of data (image data and document data) from the external apparatus 200 to the image forming apparatus 100.

The operation panel 7 includes a panel control portion 710. The panel control portion 710 is connected to the main control portion 110. Furthermore, the panel control portion 710 includes a panel CPU 711 and a panel memory 712. The panel control portion 710 (CPU 711) corresponds to a “control portion”.

Under an instruction from the main control portion 110, the panel control portion 710 controls a display action of the display portion 72. Furthermore, based on an output of the touch panel portion 73, the panel control portion 710 detects a touch operation with respect to a display screen of the display portion 72. Moreover, the panel control portion 710 also detects a press-down operation with respect to the hardware keys 74.

For example, the panel control portion 710 controls the display portion 72 to display a screen in which the software keys and so on are disposed. Upon a touch operation with respect to one of the software keys (an operation of tapping one of the software keys) being performed, based on an output of the touch panel portion 73, the panel control portion 710 detects the one of the software keys with respect to which the touch operation has been performed. Further, the panel control portion 710 controls the display portion 72 to perform switching of a display screen thereof so that a screen corresponding to the detected one of the software keys is displayed.

### <<Outline of Preview Screen>>

The operation panel 7 is equipped with a preview function. By using this preview function, respective thumbnails of a plurality of pages to be previewed can be previewed, one page at a time (it is also possible to preview thumbnails of two or more pages at a time). For example, on the operation panel 7, there is provided a preview key 74P (see FIG. 2) that is a hardware key for accepting, from a user, an instruction to use the preview function. A configuration also may be adopted in which a software key corresponding to the preview key 74P is displayed on the operation panel 7.

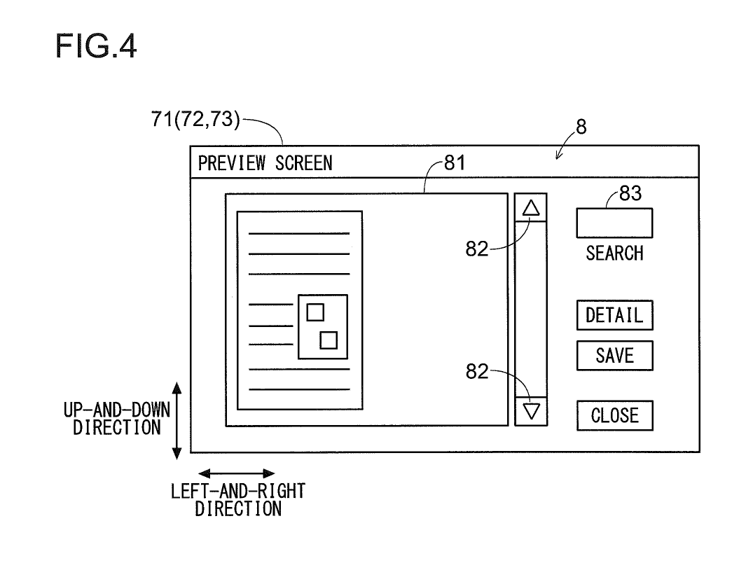

Upon an operation with respect to the preview key 74P being performed, the panel control portion 710 controls the touch panel display 71 to display a preview screen 8 as shown in FIG. 4. On the preview screen 8, a thumbnail of a user's desired page is displayed in a preview area 81. For example, image data and document data of a plurality of pages to be previewed are stored in the panel memory 712. Alternatively, in a case where an interface for connecting a USB device is provided at the operation panel 7 (or a main body of the image forming apparatus 100), image data and document data of a plurality of pages to be previewed may be stored in the USB device.

Further, in accordance with an instruction from a user (a touch operation with respect to the preview screen 8), the panel control portion 710 performs control so that switching of a page to be preview-displayed is performed. In order to accept, from a user, an instruction to perform switching of a page to be preview-displayed, a pair of page feed keys 82 (software keys) are arranged on the preview screen 8.

Upon detecting a touch operation (an operation of tapping) with respect to the page feed keys 82, the panel control portion 710 performs control so that switching of a page to be preview-displayed is performed. To be specific, upon detecting a touch operation with respect to one of the page feed keys 82 once, the panel control portion 710 performs control so that switching of a page to be displayed on the preview screen 8 from a currently displayed page to a next page is performed (so that page feed of one page is performed). Furthermore, upon detecting a touch operation with respect to the other of the page feed keys 82 once, the panel control portion 710 performs control so that switching of a page to be displayed on the preview screen 8 from a currently displayed page to a previous page is performed (so that page feed of one page is performed).

### <<Switching of Display Page>>

In this embodiment, even without using the page feed keys 82, switching of a page to be displayed on the preview screen 8 can be performed. The following specifically describes this operation.

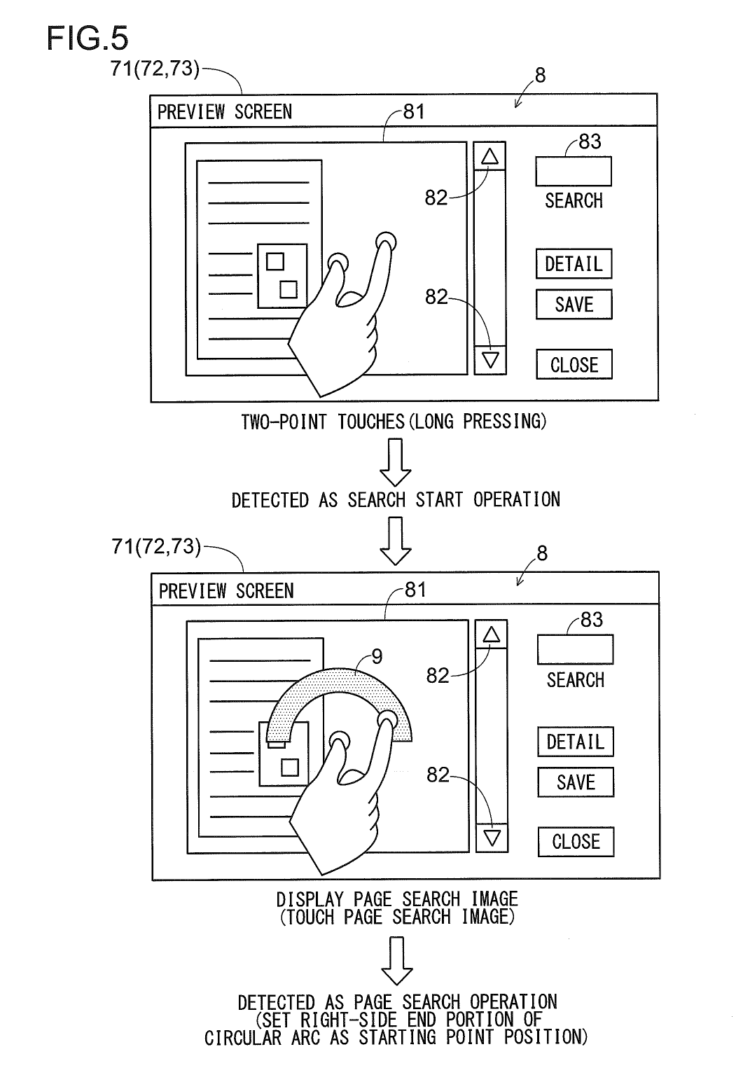

As shown in FIG. 5, upon detecting an operation of touching two points on the preview screen 8, the panel control portion 710 judges that a search start operation has been performed. In FIG. 5, each of touched positions is indicated by a hollow circle. Also in drawings referred to in the description below, similarly, each of touched positions is indicated by a hollow circle. For example, the panel control portion 710 detects, as a search start operation, a long pressing operation of keeping touching two points on the preview screen 8 until a lapse of a prescribed length of time (for example, several seconds). In this case, even upon detecting an operation of touching two points on the preview screen 8, when a touch on at least one of the two points is released before the lapse of a prescribed length of time, the panel control portion 710 does not judge that a search start operation has been performed. A long pressing operation in which, after two points on the preview screen 8 have been touched, a touch on only one of the two points is maintained until the lapse of a prescribed length of time, however, also may be used as a search start operation (a touch on the other of the two points may be released). With this configuration, when a page search is started (when a page search image 9 is displayed), there is no need to perform a touch operation with respect to the preview screen 8 multiple times, and thus improved operability is provided.

Upon detecting a search start operation, the panel control portion 710 performs control so that the page search image 9 is displayed in a superimposed manner on the preview screen 8. That is, a search start operation is an operation for displaying the page search image 9. The page search image 9 is an image for accepting an after-mentioned page search operation (an operation for searching for a page to be displayed on the preview screen 8).

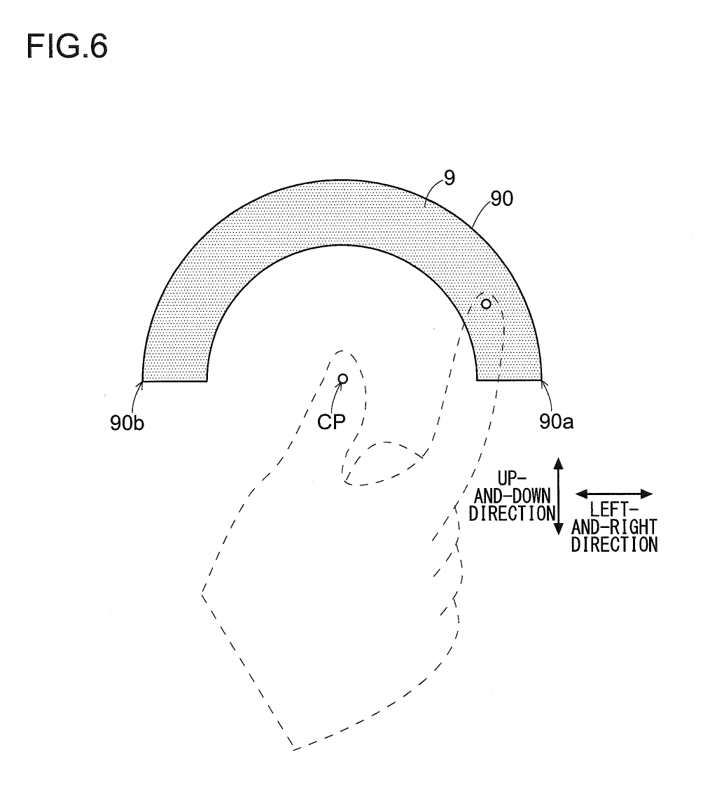

As shown in FIG. 6, the page search image 9 is an image having a circular arc shape about a center position CP. In other words, the page search image 9 is an image including a circular arc 90 about the center position CP. For example, a pair of end portions 90a and 90b of the circular arc 90 are disposed, respectively, on both sides of the center position CP in a left-and-right direction.

The center position CP is a position set by the panel control portion 710 and is a touched position of one of two-point touches detected as a search start operation. For example, with respect to touched positions of two-point touches detected as a search start operation, the panel control portion 710 sets, as the center position CP, that one of them which is positioned below the other in an up-and-down direction. The up-and-down direction is a direction orthogonal to an extending direction of an upper side (lower side) of the preview screen 8 and is an extending direction of a left side (right side) of the preview screen 8. That is, in an example shown in FIG. 5, that one of touched positions of two-point touches which is touched with a thumb (that one of them which is at a shorter distance from the lower side of the preview screen 8) is set as the center position CP.

Although there is no particular limitation, a configuration of the page search image 9 (a color, shape, and size of the image) is preset and does not vary depending on touched positions of two-point touches detected as a search start operation and an inter-touch distance between the two-point touches. That is, even when a search start operation is performed based on touched positions and an inter-touch distance different from those in the example shown in FIG. 5, while a display position of the page search image 9 varies depending on the touched positions used in the search start operation, the configuration of the page search image 9 does not vary.

A configuration, however, may be adopted in which depending on an inter-touch distance between two-point touches detected as a search start operation, a display size of the page search image 9 (a radius of the circular arc 90) is made to vary. For example, a configuration may be adopted in which in a case of an inter-touch distance larger than a preset upper limit value, a display size of the page search image 9 is set to a preset maximum size, in a case of an inter-touch distance smaller than a preset lower limit value, the display size of the page search image 9 is set to a preset minimum size, and in a case of an inter-touch distance that falls within a range from the upper limit value to the lower limit value, the display size of the page search image 9 is set to a preset intermediate size (a size between the maximum size and the minimum size).

As shown in FIG. 5, after the page search image 9 has been displayed, upon detecting an operation in which, while a touch on the center position CP (one of two-point touches performed as a search start operation) is continued, a display region of the page search image 9 is touched, the panel control portion 710 judges that a page search operation that is an operation for searching for a page to be displayed on the preview screen 8 has been performed. For example, while one of two-point touches performed as a search start operation is maintained, the other of the two-point touches is released, after which a display region of the page search image 9 is newly touched, and such an operation is detected as a page search operation. Alternatively, while one and the other of the touches are maintained, a touched position of the other of the touches is moved to a display region of the page search image 9, and such an operation is detected as a page search operation.

In a case where when the page search image 9 is displayed by performing two-point touches as a search start operation, a touched position of the other of the two-point touches (a touched position different from a touched position set as the center position CP) coincides with a display region of the page search image 9, a condition for being detected as a page search operation is met, and thus in this case, it is understood that a page search operation has been performed.

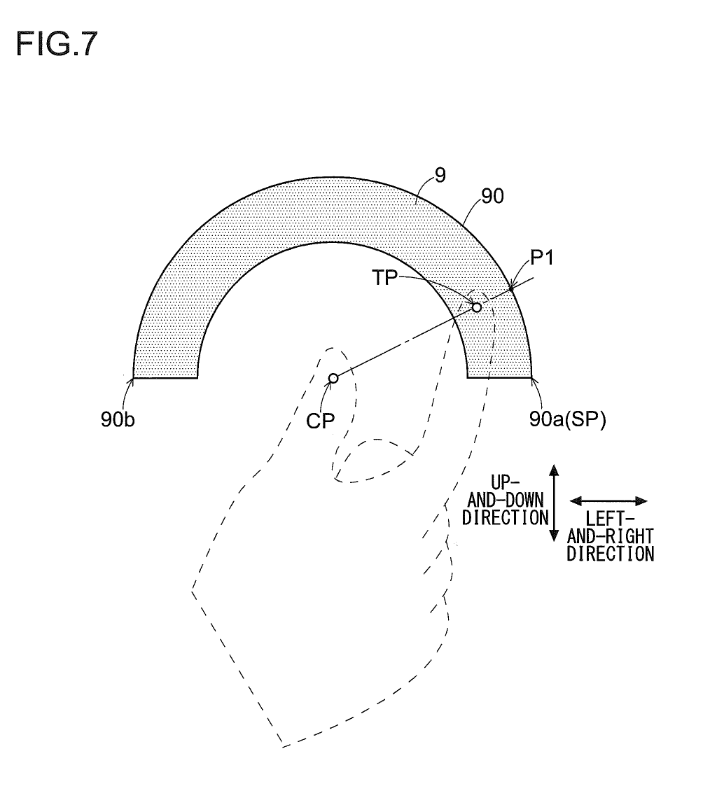

As shown in FIG. 7, upon detecting a page search operation, the panel control portion 710 recognizes a touched position TP of the other of two-point touches detected as the page search operation (a touched position in a display region of the page search image 9). Hereinafter, the touched position of the other of two-point touches may be referred to as a subject touched position TP so as to be distinguished from a touched position (center position CP) of one of the two-point touches detected as the page search operation. Further, based on the subject touched position TP, the panel control portion 710 performs control so that switching of a page to be displayed on the preview screen 8 is performed. That is, in a state where the center position CP of the circular arc 90 of the page search image 9 is being touched, a display region of the page search image 9 is touched, and thus a page to be displayed on the preview screen 8 is switched from a currently displayed page (a display page at the time of performing a search start operation) to another page.

To be specific, upon detecting a page search operation, the panel control portion 710 sets, as a first position P1, a position on the circular arc 90 corresponding to the subject touched position TP. At this time, the panel control portion 710 sets, as the first position P1, a position on the circular arc 90 in closest proximity to the subject touched position TP. In other words, an intersection of a straight line passing through the subject touched position TP and the center position CP (indicated by an alternate long and short dashed line in FIG. 7) and the circular arc 90 is set as the first position P1.

Furthermore, the panel control portion 710 sets, as a starting point position SP, an end point position of either of the pair of end portions 90a and 90b of the circular arc 90 in a circumference direction thereof. For example, the panel control portion 710 recognizes, as a set reference position (a position for setting the starting point position SP), a touched position of the other of touches different from a touched position of one of the touches set as the center position CP at the time of detecting a search start operation. Further, in a case where the set reference position is on a right side in the left-and-right direction with respect to the center position CP, the panel control portion 710 sets, as the starting point position SP, the end point position of the end portion 90a of the circular arc 90 on the right side in the left-and-right direction. On the other hand, in a case where the set reference position is on a left side in the left-and-right direction with respect to the center position CP, the panel control portion 710 sets, as the starting point position SP, the end point position of the end portion 90b of the circular arc 90 on the left side in the left-and-right direction.

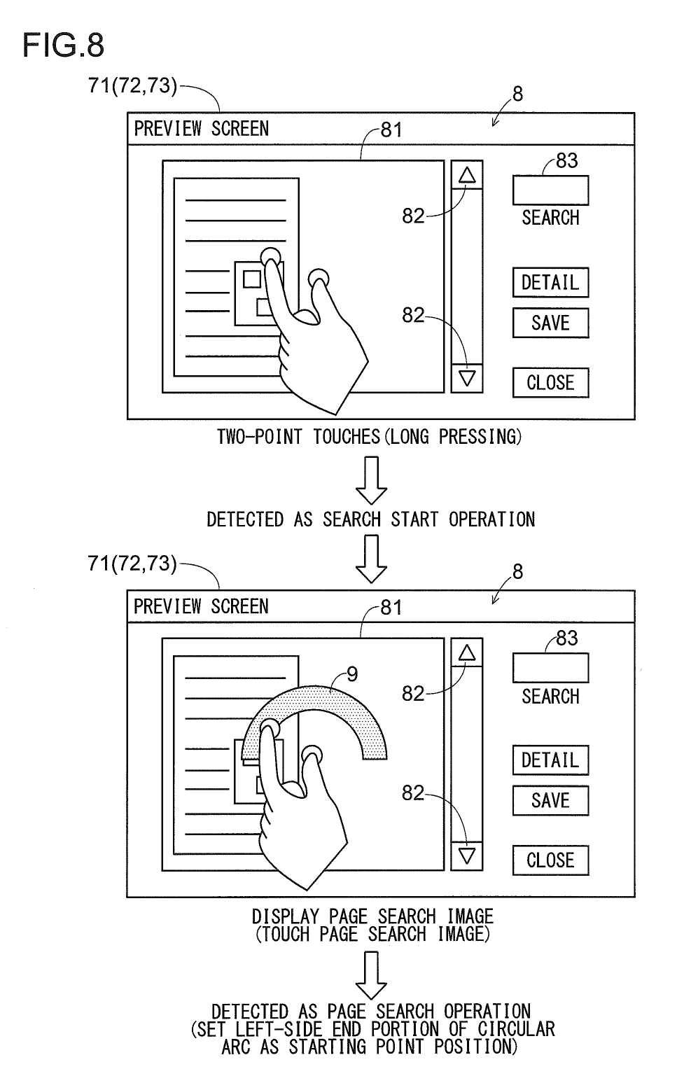

Accordingly, in a case where a search start operation has been performed as shown in FIG. 5, the end point position of the right-side end portion 90a of the circular arc 90 is set as the starting point position SP (see FIG. 7). On the other hand, in a case where a search start operation has been performed as shown in FIG. 8, the end point position of the left-side end portion 90b of the circular arc 90 is set as the starting point position SP (not shown). That is, in a case where a search start operation has been performed with a right hand, it is likely that the end point position of the right-side end portion 90a of the circular arc 90 is set as the starting point position SP, while in a case where a search start operation has been performed with a left hand, it is likely that the end point position of the left-side end portion 90b of the circular arc 90 is set as the starting point position SP.

Once the first position P1 and the starting point position SP have been set, the panel control portion 710 determines a first ratio that is a ratio of a circular arc length (a length in the circumference direction) of the circular arc 90 between the starting point position SP and the first position P1 to a total length of the circular arc 90. The total length of the circular arc 90 is a circular arc length (a length in the circumference direction) of the circular arc 90 between the end point position of the end portion 90a thereof (starting point position SP) and the end point position of the end portion 90b thereof. Further, the panel control portion 710 performs control so that a value of a page number of a page to be displayed on the preview screen 8 increases with increasing value of the first ratio.

For example, the panel control portion 710 determines a value obtained by multiplying a total number of pages of a plurality of pages to be previewed (the number of pages from a first page to a last page) by the first ratio. Then, the panel control portion 710 performs control so that a page having a page number corresponding to said determined value is displayed on the preview screen 8. That is, when the total number of pages of a plurality of pages to be previewed is “100” and the first ratio has a value of “0.2”, a value obtained by multiplying the total number of pages by the first ratio is “20”. Accordingly, on the preview screen 8, a page having a page number whose value is “20 (a 20^{th} page counted from the first page)” is displayed. In a case where a value obtained by multiplying a total number of pages by the first ratio is a decimal, a value after a decimal point may be round up, round down, or round off. With this configuration, by performing a page search operation in such a manner that a ratio of the number of pages between a page number of a first page (a lowest page number) and a page number of a desired page to a total number of pages of a plurality of pages agrees with the first ratio, the desired page can be displayed on the preview screen 8.

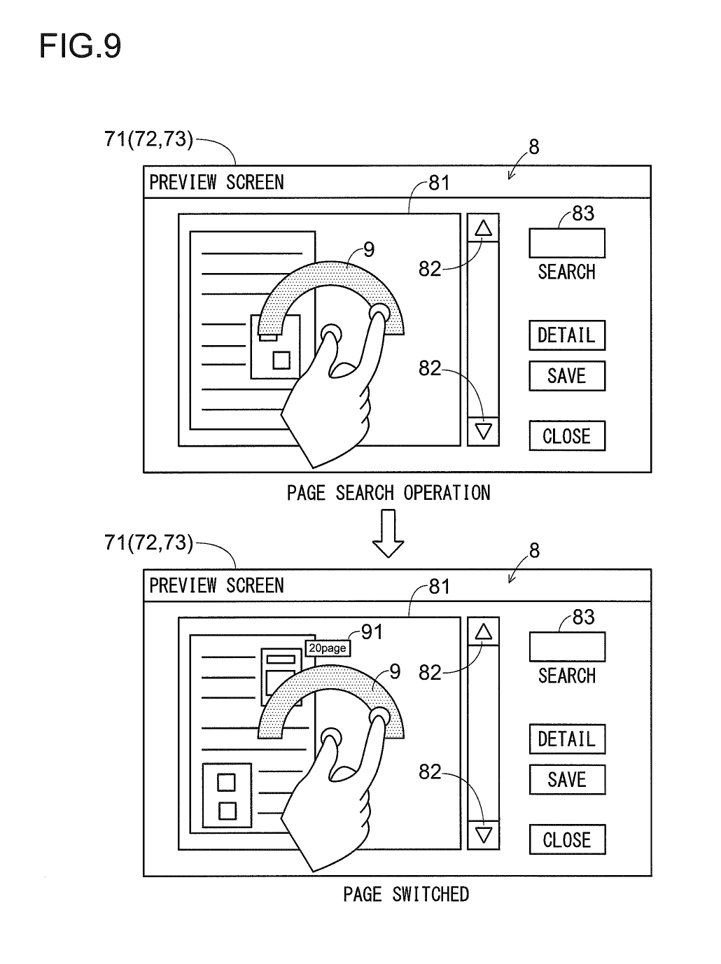

Furthermore, as shown in FIG. 9, when displaying a page corresponding to a page search operation (in a case where switching of a display page has been performed), the panel control portion 710 performs control so that page number information 91 indicating a page number of said page is displayed. Although there is no particular limitation, the page number information 91 is displayed in a preview area 81 of the preview screen 8. Alternatively, the page number information 91 may be displayed in a preset region (for example, a region outside the preview area 81).

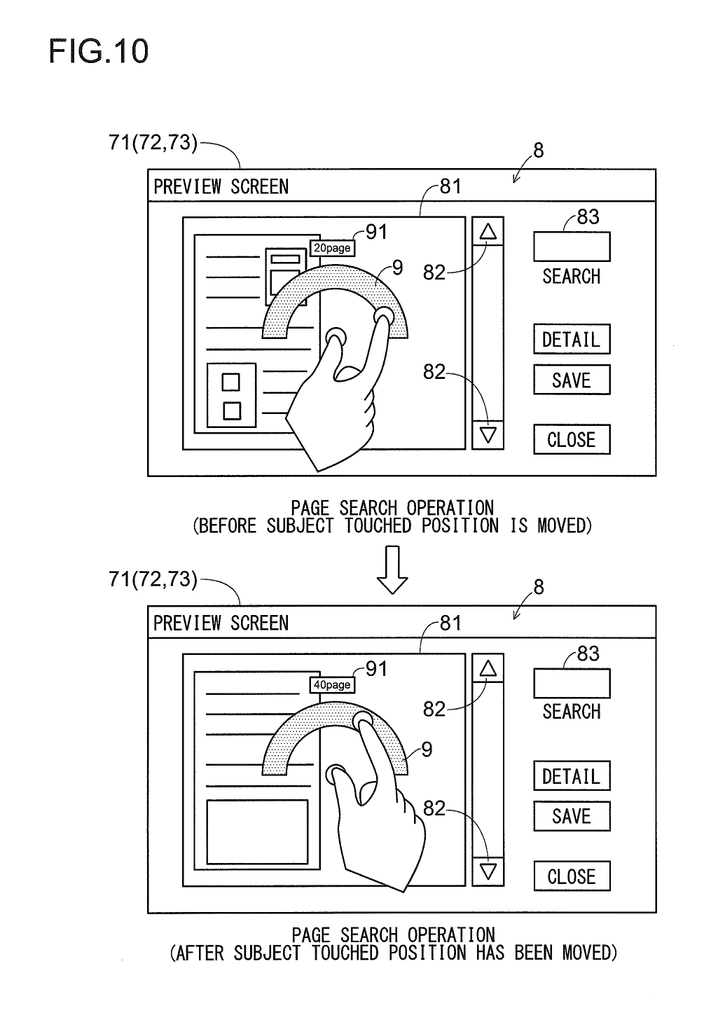

After that, an operation in which, while the center position CP of the circular arc 90 of the page search image 9 is being touched, the subject touched position TP is moved (an operation in which the subject touched position TP is moved along a display region of the page search image 9) is performed. Every time this operation is performed, the first position P1 corresponding to the subject touched position TP is determined, and the first ratio is determined. Further, as shown in FIG. 10, a page corresponding to the first position P1 (a page having a page number corresponding to a value obtained by multiplying a total number of pages by the first ratio) is displayed on the preview screen 8. That is, a page displayed on the preview screen 8 is switched one after another.

The panel control portion 710 recognizes (sets) beforehand respective page numbers of a plurality of pages to be previewed. For example, in a case where the plurality of pages are compiled in a single file, the panel control portion 710 recognizes a page number of a first page as “1 (a lowest page number)” and a page number of a N^{th} page from the first page as “N”. Furthermore, in a case where the plurality of pages are divided into separate files, based on respective file names and dates and times of creation of a plurality of these files, the panel control portion 710 sets page numbers.

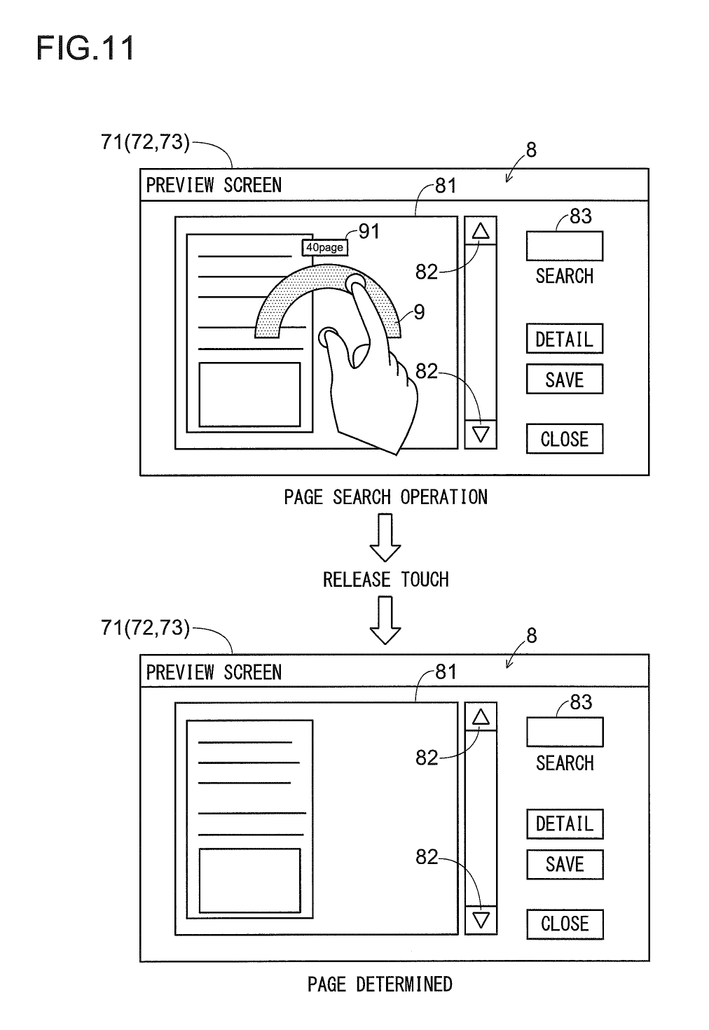

As shown in FIG. 11, in a case where, at the time of and after detection of a search start operation, regardless of whether or not a page search operation has been detected, all touches on the preview screen 8 are released, the panel control portion 710 judges that a page to be displayed on the preview screen 8 has been determined. FIG. 11 shows a display action in a case where, at the time of and after detection of a page search operation, all touches on the preview screen 8 are released. At this time, the panel control portion 710 performs control so that the page search image 9 is stopped from being displayed. Furthermore, the panel control portion 710 performs control so that a page currently displayed on the preview screen 8 is maintained to be displayed thereon (said page is displayed as a determined page). With this configuration, after a desired page has been displayed on the preview screen 8, it is only necessary to release all touches on (to release a finger from) the preview screen 8.

### <<Display of Search Assistance Information>>

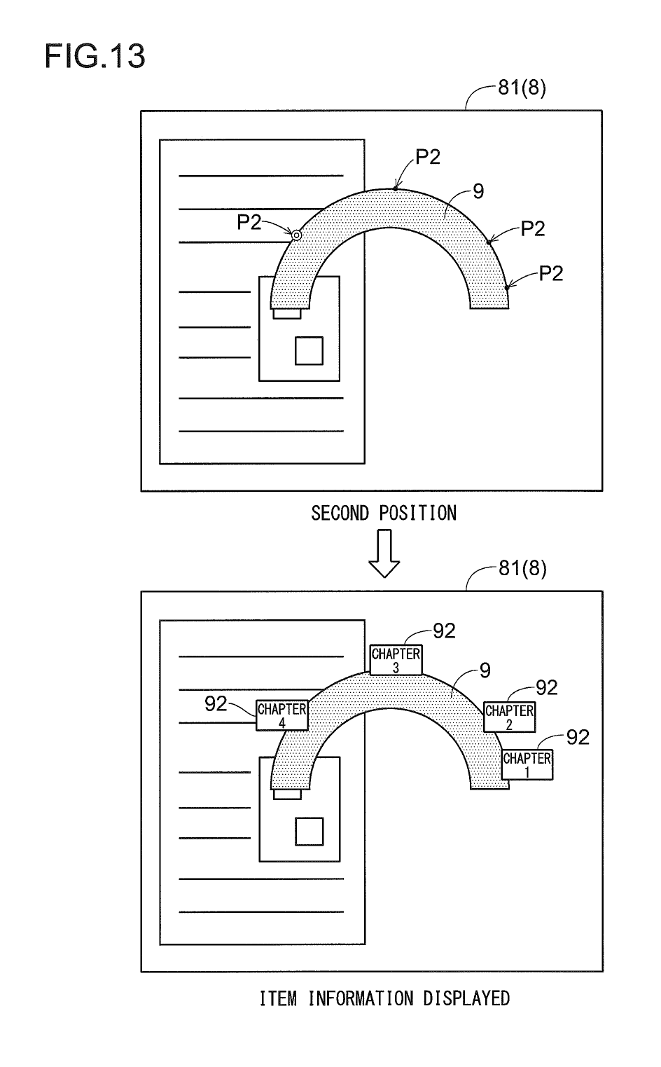

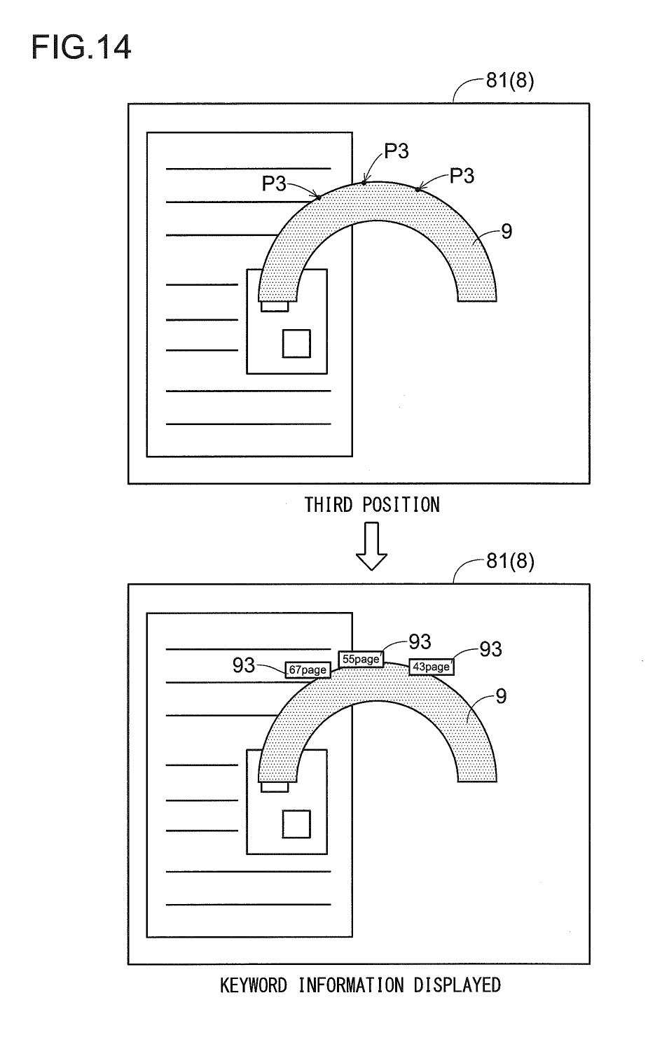

When displaying the page search image 9, the panel control portion 710 performs control so that search assistance information for assisting in performing a page search also is additionally displayed. For example, the panel control portion 710 performs control so that, as search assistance information, item information 92 indicating an item name of each item is displayed (see FIG. 13). Alternatively, the panel control portion 710 performs control so that, as search assistance information, keyword information 93 indicating a page number of a page containing a keyword inputted by a user is displayed (see FIG. 14). For the sake of easy viewing of the drawings, FIG. 13 and FIG. 14 do not show a user's finger.

### <Item Information>

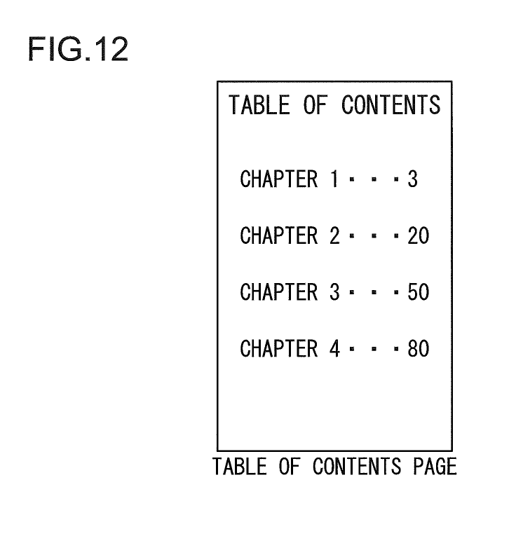

The panel control portion 710 judges whether or not a plurality of pages to be previewed are classified by items. For example, the panel control portion 710 judges whether or not, among pieces of data of the plurality of pages, there is one corresponding to a table of contents page, and when there is, the panel control portion 710 judges that the plurality of pages are classified by items. As one example, the panel control portion 710 searches for a page containing a plurality of numerals and a prescribed character string (for example, a character string such as “Contents” or “Index”). Then, in a case where there is said page, the panel control portion 710 extracts said page as the table of contents page (judges that the plurality of pages are classified by items). For example, a page as shown in FIG. 12 is extracted as the table of contents page.

Furthermore, based on the piece of data of the table of contents page, the panel control portion 710 performs identification of an item name of each item and a page number (hereinafter, referred to as an item page number) of a first page of each item. For example, on the table of contents page shown in FIG. 12, a character string “Chapter X” (a numeral is substituted for “X”) is identified as an item name. Furthermore, a numeral accompanying the character string “Chapter X” is identified as an item page number.

After that, with respect to each item, the panel control portion 710 recognizes, among the plurality of pages to be previewed, the number of pages (herein, referred to as a subject number of pages) from a lowest page number to the item page number. Furthermore, the panel control portion 710 determines a second ratio that is a ratio of the subject number of pages to a total number of pages of the plurality of pages, and further performs, with respect to each item, a process in which a position on the circular arc 90 such that a ratio of a circular arc length of the circular arc 90 between the starting point position SP and this position to the total length of the circular arc 90 is equal to the second ratio is determined as a second position P2 (see FIG. 13) corresponding to the each item.

Further, as shown in FIG. 13, when displaying the page search image 9, the panel control portion 710 performs control so that an item name of each item (item information 92) is displayed at the second position P2 corresponding thereto or at a vicinity thereof. With this configuration, a page search operation can be performed by using, as an index, an item name displayed additionally to the page search image 9. Thus, a page search can be performed efficiently. For example, it is assumed that a total number of pages of a plurality of pages to be previewed is “100”. In this case, in the table of contents page shown in FIG. 12, when an item “Chapter 4” is used as an example, an item page number of said item is “80”, so that the second ratio has a value of “0.8”. Thus, as shown in FIG. 13, a position (indicated by a double circle) at 80% of the total length of the circular arc 90 is determined to be a position as the second position P2 corresponding to the item page number “80”.

### <Keyword Information>

The panel control portion 710 performs control so that a search box 83 (see FIG. 4) for inputting a keyword therein is displayed on the preview screen 8 and so that an operation for inputting a keyword in the search box 83 is accepted. For example, upon detecting a touch operation with respect to the search box 83 (an operation of tapping the search box 83), the panel control portion 710 performs control so that a software keyboard (not shown) is displayed. This enables inputting a keyword in the search box 83 by use of the software keyboard.

Further, upon a keyword being inputted in the search box 83, from among a plurality of pages to be previewed, the panel control portion 710 searches for a page containing the keyword inputted in the search box 83. Then, in a case where there is a page containing the keyword, the panel control portion 710 performs identification of a page number (hereinafter, referred to as an applicable page number) of the page containing the keyword. There may be a plurality of pages containing the keyword.

After that, the panel control portion 710 recognizes, among the plurality of pages to be previewed, the number of pages (herein, referred to as a subject number of pages) from a lowest page number to the applicable page number. Furthermore, the panel control portion 710 determines a third ratio that is a ratio of the subject number of pages to a total number of pages of the plurality of pages, and further determines a position on the circular arc 90 such that a ratio of a circular arc length of the circular arc 90 between the starting point position SP and this position to the total length of the circular arc 90 is equal to the third ratio as a third position P3 corresponding to the applicable page number (see FIG. 14). In a case where there are a plurality of pages containing the keyword (in a case where there are a plurality of applicable page numbers), the third positions P3 corresponding to the applicable page numbers, respectively, are determined.

Further, as shown in FIG. 14, when displaying the page search image 9, the panel control portion 710 performs control so that an applicable page number (keyword information 93) is displayed at the third position P3 or at a vicinity thereof. FIG. 14 shows, as one example, an example in which page numbers of 3 pages are identified as applicable page numbers (page numbers of pages containing a keyword). With this configuration, a page search operation can be performed by using, as an index, an applicable page number (a page number of a page containing a keyword) displayed additionally to the page search image 9. Thus, a page search can be performed efficiently.

### <<Flow of Process at Time of Performing Preview Display>>

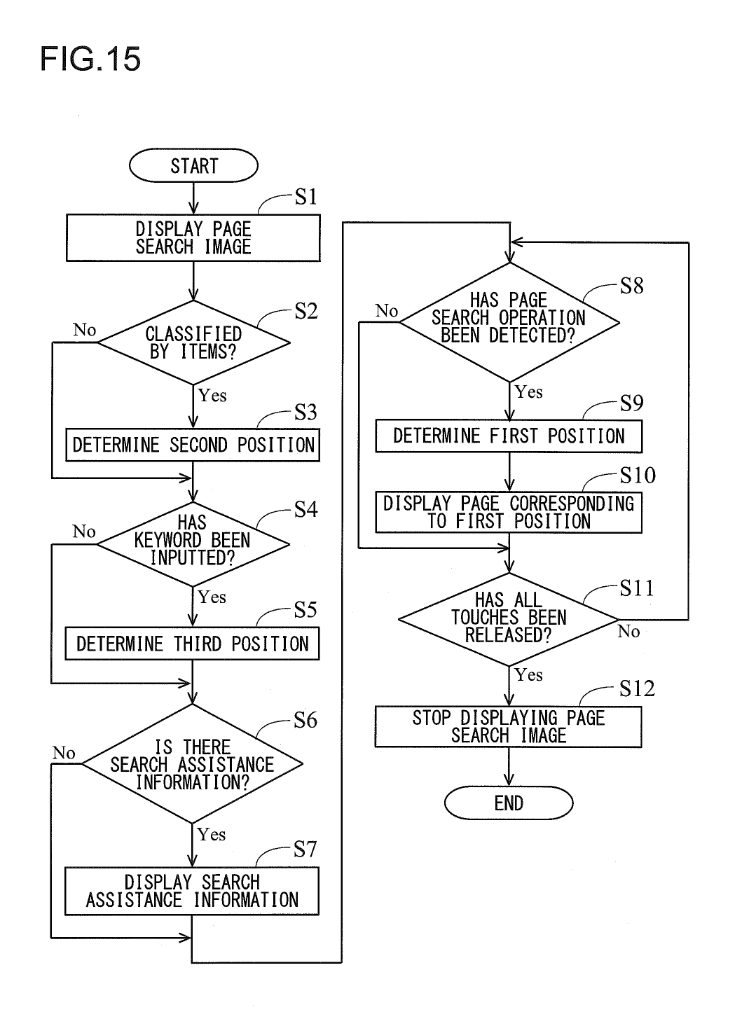

With reference to a flow chart shown in FIG. 15, the following describes a flow of a process at the time of displaying a page on the preview screen 8 (at the time of performing switching of a page). It is assumed that, at a start point in time in the flow chart shown in FIG. 15, the preview screen 8 has been displayed. Further, when a search start operation (a touch operation of long pressing two points on the preview screen 8) is performed with respect to the preview screen 8, the flow chart shown in FIG. 15 is started.

At Step S1, the panel control portion 710 performs control so that the page search image 9 is displayed on the preview screen 8.

Subsequently, at Step S2, the panel control portion 710 judges whether or not a plurality of pages to be previewed are classified by items. In other words, the panel control portion 710 judges whether or not the plurality of pages are classifiable by items. In a case where, as a result thereof, the panel control portion 710 judges that the plurality of pages are classified by items, a transition is made to Step S3. Upon the transition to Step S3, the panel control portion 710 determines the second position P2. At this time, the panel control portion 710 performs control so that information indicating the second position P2 and information indicating an item name to be displayed at the second position P2 (a vicinity thereof) are stored in the panel memory 712). After that, a transition is made to Step S4. In a case where, at Step S2, the panel control portion 710 judges that the plurality of pages are not classified by items, a transition is made from Step S2 to Step S4.

Upon the transition to Step S4, the panel control portion 710 judges whether or not a keyword has been inputted in the search box 83 on the preview screen 8. In a case where, as a result thereof, the panel control portion 710 judges that a keyword has been inputted therein, a transition is made to Step S5. Upon the transition to Step S5, the panel control portion 710 determines the third position P3. At this time, the panel control portion 710 performs control so that information indicating the third position P3 and information indicating an applicable page number to be displayed at the third position P3 (a vicinity thereof) are stored in the panel memory 712. After that a transition is made to Step S6. In a case where, at Step S4, the panel control portion 710 judges that a keyword has not been inputted therein, a transition is made from Step S4 to Step S6.

Upon the transition to Step S6, the panel control portion 710 judges whether or not there is search assistance information (an item name or an applicable page number) to be displayed on the preview screen 8. In a case where, as a result thereof, the panel control portion 710 judges that there is search assistance information, a transition is made to Step S7. Upon the transition to Step S7, the panel control portion 710 performs control so that the search assistance information is displayed. In a case where there is an item name as the search assistance information, the item name is displayed at the second position P2, and in a case where there is an applicable page number as the search assistance information, the applicable page number is displayed at the third position P3. After that, a transition is made to Step S8. In a case where, at Step S6, the panel control portion 710 judges that there is no search assistance information, a transition is made from Step S6 to Step S8.

Upon the transition to Step S8, the panel control portion 710 judges whether or not a page search operation has been detected. In a case where, as a result thereof, the panel control portion 710 judges that a page search operation has been detected, a transition is made to Step S9. Upon the transition to Step S9, the panel control portion 710 determines the first position P1 (a position corresponding the subject touched position TP). At this time, the panel control portion 710 also determines the first ratio. Further, at Step S10, the panel control portion 710 performs control so that a page corresponding to the first position P1 (a page having a page number corresponding to a value obtained by multiplying a total number of pages by the first ratio) is displayed on the preview screen 8.

After that, a transition is made to Step S11. Furthermore, also in a case where, at Step S8, the panel control portion 710 judges that a page search operation has not been detected, a transition is made to Step S11. Upon the transition to Step S11, the panel control portion 710 judges whether or not all touches on the preview screen 8 have been released. In a case where, as a result thereof, the panel control portion 710 judges that all touches have been released, a transition is made to Step S12. On the other hand, in a case where the panel control portion 710 judges that all touches have not been released (a touch on the center position CP has been continued), a transition is made to Step S8.

Upon the transition to step S12, the panel control portion 710 performs control so that the page search image 9 is stopped from being displayed. At this time, the panel control portion 710 performs control so that a currently displayed page is continued to be displayed. That is, on the preview screen 8, a page displayed at the time of releasing all touches on the preview screen 8 is continued to be displayed (a display page is determined).

In this embodiment, as described above, upon detecting a search start operation that is an operation of touching two points on the preview screen 8, the panel control portion 710 sets, as the center position CP, either of touched positions of two-point touches detected as the search start operation, and performs control so that the page search image 9 that is an image having a circular arc shape including the circular arc 90 about the center position CP is displayed. Furthermore, after the page search image 9 has been displayed, upon detecting a page search operation that is an operation in which, while the touch on the center position CP is continued, the page search image 9 is touched, the panel control portion 710 sets, as the first position P1, a position on the circular arc 90 corresponding to the touched position of the touch on the page search image 9 (subject touched position TP), and sets, as the starting point position SP, a position of either of the pair of end portions 90a and 90b of the circular arc 90. The panel control portion 710 further determines the first ratio that is a ratio of a length of the circular arc 90 between the starting point position SP and the first position P1 to the total length of the circular arc 90, and performs control so that a value of a page number of a page to be displayed on the preview screen 8 increases with increasing value of the first ratio.

According to a configuration of this embodiment, after a search start operation has been performed (after the page search image 9 has been displayed), by performing a page search operation (an operation of touching the page search image 9) in such a manner that the first ratio has an increased value, page feed of a plurality of pages is performed at a stroke. Thus, even in a case where a page number of a desired page (a page desired by a user to be displayed) is much higher/lower than a page number of a page currently displayed on the preview screen 8, without performing the same operation multiple times, switching of a display page from the currently displayed page to the desired page can be performed.

Furthermore, in this embodiment, as described above, with respect to touched positions of two-point touches detected as a search start operation, the panel control portion 710 sets, as the center position CP, that one of them which is positioned below the other in the up-and-down direction. When the touched position (set reference position) of the other of the touches different from the touched position of one of the touches set as the center position CP at the time of detecting the search start operation is on a right side in the left-and-right direction with respect to the center position CP, the panel control portion 710 sets, as the starting point position SP, a position of the end portion 90a of the pair of end portions 90a and 90b of the circular arc 90, which is on the right side with respect to the center position CP, while when the set reference position is on a left side in the left-and-right direction with respect to the center position CP, the panel control portion 710 sets, as the starting point position SP, a position of the end portion 90b of the pair of end portions 90a and 90b of the circular arc 90, which is on the left side with respect to the center position CP. With this configuration, the starting point position SP can be changed depending on a dominant arm of a user (improved operability can be provided).

The embodiment disclosed herein is to be construed in all respects as illustrative and not limiting. The scope of the present disclosure is indicated by the appended claims rather than by the foregoing description of the embodiment, and all changes that come within the meaning and range of equivalency of the claims are intended to be embraced therein.

What is claimed is:

1. A display input device, comprising:
a control portion that is provided with a CPU;
a display portion that, under control by the control portion, displays a preview screen for previewing a plurality of pages page by page; and
a touch panel portion that is provided on the display portion and is used to detect a touch operation with respect to the preview screen,
wherein
based on an output of the touch panel portion, the control portion performs detection of the touch operation, and upon detecting an operation, as the touch operation, of touching two points on the preview screen, the control portion judges that a search start operation that is performed to search for a page desired by a user to be displayed has been detected, in which case, the control portion sets, as a center position, either of touched positions of two-point touches detected as the search start operation, and controls the display portion to display a page search image that is an image having a circular arc shape including a circular arc about the center position, and
after the page search image has been displayed, upon detecting a page search operation that is an operation as the touch operation in which, while the touch on the center position is continued, the page search image is touched, the control portion sets, as a first position, a position on the circular arc corresponding to a touched position of a touch on the page search image, sets, as a starting point position, a position of either of a pair of end portions of the circular arc, determines a first ratio that is a ratio of a length of the circular arc between the starting point position and the first position to a total length of the circular arc, and controls the display portion to perform switching of a page to be displayed on the preview screen in such a manner that a value of a page number of the page to be displayed on the preview screen by the display portion increases with increasing value of the first ratio.

2. The display input device according to claim 1, wherein
the control portion determines a value obtained by multiplying a total number of pages of the plurality of pages by the first ratio, and performs control so that a page having a page number corresponding to said determined value is displayed on the preview screen.

3. The display input device according to claim 1, wherein
in a case where the plurality of pages are classified by items, the control portion identifies an item name of each item and an item page number that is a page number of a first page of the each item, determines a second ratio that is a ratio of a number of pages between a lowest page number and the item page number to a total number of pages of the plurality of pages, further performs, with respect to the each item, a process in which a position on the circular arc such that a ratio of a length of the circular arc between the starting point position and this position to the total length of the circular arc is equal to the second ratio is determined as a second position corresponding to the each item, and performs control so that the item name of the each item is displayed at the second position corresponding thereto or at a vicinity of the second position.

4. The display input device according to claim 1, wherein
the control portion performs control so that a search box for inputting a keyword therein is displayed on the preview screen and so that an operation for inputting the keyword in the search box is accepted, and
in a case where the keyword has been inputted in the search box, the control portion identifies an applicable page number that is a page number of a page containing the keyword inputted in the search box, determines a third ratio that is a ratio of a number of pages between a lowest page number and the applicable page number to a total number of pages of the plurality of pages, further determines a position on the circular arc such that a ratio of a length of the circular arc between the starting point position and this position to the total length of the circular arc is equal to the third ratio is determined as a third position corresponding to the applicable page number, and performs control so that the applicable page number is displayed at the third position or at a vicinity of the third position.

5. The display input device according to claim 1, wherein
as the search start operation, the control portion detects an operation, as the touch operation, of keeping touching two points on the preview screen until a lapse of a prescribed length of time.

6. The display input device according to claim 1, wherein
at a time of and after detection of the search start operation, upon detecting that all touches on the preview screen have been released, the control portion performs control so that while a page currently displayed on the preview screen is continued to be displayed, the page search image is stopped from being displayed.

7. The display input device according to claim 1, wherein
with respect to the touched positions of two-point touches detected as the search start operation, the control portion sets, as the center position, that one of them which is positioned below the other in an up-and-down direction, and
when the touched position of the other of the touches different from the touched position of one of the touches set as the center position at a time of detecting the search start operation is on a right side in a left-and-right direction with respect to the center position, the control portion sets, as the starting point position, a position of one of the pair of end portions of the circular arc, which is on the right side with respect to the center position, while when the touched position of the other of the touches is on a left side in the left-and-right direction with respect to the center position, the control portion sets, as the starting point position, a position of the other of the pair of end portions of the circular arc, which is on the left side with respect to the center position.

8. An image forming apparatus comprising the display input device according to claim 1.

9. A method for controlling a display input device comprising a display portion that displays a preview screen for previewing a plurality of pages page by page and a touch panel portion that is provided on the display portion and is used to detect a touch operation with respect to the preview screen, the method comprising:
a step in which, based on an output of the touch panel portion, a touch operation is detected, and upon detecting an operation, as the touch operation, of touching two points on the preview screen, it is judged that a search start operation that is performed to search for a page desired by a user to be displayed has been detected, in which case, either of touched positions of two-point touches detected as the search start operation is set as a center position, and the display portion is controlled to display a page search image that is an image having a circular arc shape including a circular arc about the center position; and
a step in which, after the page search image has been displayed, upon detecting a page search operation that is an operation as the touch operation in which, while the touch on the center position is continued, the page search image is touched, a position on the circular arc corresponding to a touched position of a touch on the page search image is set as a first position, a position of either of a pair of end portions of the circular arc is set as a starting point position, a first ratio that is a ratio of a length of the circular arc between the starting point position and the first position to a total length of the circular arc is determined, and the display portion is controlled to perform switching of a page to be displayed on the preview screen in such a manner that a value of a page number of the page to be displayed on the preview screen by the display portion increases with increasing value of the first ratio.
